(19) United States
(12) Patent Application Publication
(10) Pub. No.: US 2014/0362749 A1
(43) Pub. Date: Dec. 11, 2014

(54) WIRELESS DEVICES AND CONTROL METHOD

(71) Applicant: NO STRINGS TOYS, LLC, Chandler, AZ (US)

(72) Inventor: Rodney Kenji Nakamoto, Chandler, AZ (US)

(73) Assignee: NO STRINGS TOYS, LLC, Chandler, AZ (US)

(21) Appl. No.: 14/361,934

(22) PCT Filed: Nov. 30, 2012
(86) PCT No.: PCT/US12/67264

§ 371 Date: May 30, 2014

Related U.S. Application Data
(60) Provisional application No. 61/566,189, filed on Dec. 2, 2011.

(51) Int. Cl. H04B 1/38; H04L 29/08; H04W 88/02

(52) U.S. Cl. CPC H04B 1/38; H04W 88/02; H04L 67/34
USPC 370/310

(57) ABSTRACT

Using wireless communications, one or more action devices, or a host device and one or more action devices are wirelessly connected and define a networked system. The devices have the ability to discover other devices wirelessly as those other devices come online within the same network, automatically adjust for the additional devices, and initiate intelligent interaction between one or more connected devices, A host device and action device are capable to effectively manage data to ensure no data is lost. The host device controls the timing and distribution of data to one or more multiple devices simultaneously in an asynchronous or synchronous manner that results in a coordinated and choreographed implementation of the system, The networked system and method utilize existing equipment without the need to obtain specialized equipment or modify the current operational aspects of existing technology by simultaneous use of multiple layers of the TCP/IP network stack.

### RELATED APPLICATION

This application claims the benefit of U.S. Provisional Application No. 61/566,189 filed on Dec. 2, 2011, which is hereby incorporated by reference in its entirety.

### BACKGROUND

Current wireless networked systems include, one or more connected devices, and/or a host and one or more connected devices. In current networked systems, a single host is unable to coordinate and control multiple devices, especially for configurations where there is a high data transference rate. These systems do not account for situations where one or more of the connected devices within the system cannot maintain the current data transference rate, and as a result, data is lost. Further, these systems also require specialized equipment or invasive modifications to the operation of existing infrastructure or equipment currently in use and possession by most of the general population.

In addition, current wireless networked systems comprising one or more connected devices do not have the ability to discover other devices as those other devices come online within the same network, automatically adjust for additional devices as the additional devices subsequently make themselves aware on the same network, and initiate intelligent interaction between one or more connected devices.

Therefore, a need exists for one or more connected devices using IEEE 802.11 technology and successors thereof to have the ability to discover other devices as those other devices come online within the same network, automatically adjust for the additional devices, and initiate intelligent interaction between one or more connected devices.

A need exists for a single device with the ability to effectively manage data to ensure coordination and control of one or more multiple devices simultaneously in an asynchronous or synchronous manner that results in a coordinated and choreographed implementation of the system. Further, a need exists to utilize existing infrastructure and equipment without the need to obtain specialized equipment or modify the current operational aspects of existing technology by simultaneous use of multiple layers of the transmission control protoc (TCP/IP) network stack.

### SUMMARY

A networked system comprises a host device capable of bi-directionally sending and receiving wireless communications using a first communication protocol and a second communication protocol. The host device is configured to operate in either a first or a second operation mode. The networked system also include an action device capable of bi-directionally sending and receiving wireless communications using the first and second communication protocols. The action device is configured to wirelessly communicate with the host device. The action device is also configured to operate in either a first or a second operation mode. The host device and action device are in the same operation mode. The first and second communication protocols are different. The host device is configured to control the action device and process communications received from the action device.

A networked system is defined by a host device and an action device. The networked system configured to operate in either a first or a second operation mode. The networked system comprises an action device configured to wirelessly communicate using a first communication protocol and a second communication protocol. The action device includes a first wireless transceiver for receiving and sending wireless communications, a processor operably coupled to the first wireless transceiver. The processor provides for data management of the action device, processing of wireless communications, and management of movement of the action device. The networked system also includes a host device configured to wirelessly communicate with the action device using the first communication protocol and the second communication protocol. The host device includes a second wireless transceiver for receiving and sending wireless communications. The host device also includes a host control application operably coupled to the second wireless transceiver, and the host control application manages and processes communications between the host device and the action device. The host control application provides for command and control of the action device. The host device and action device utilize the first and second communication protocols to manage communications with each other.

A system comprising a first action device having an action control module attached therewith. The action control module including a transceiver for bi-directionally sending and receiving wireless communications using a first communication protocol and a second communication protocol and a processor electrically coupled to the transceiver. The processor provides data management of and for the action device. The processor also processes the wireless communications, and manages movement of the action device. The action control module also includes an audio unit operably coupled to the processor for sending and receiving audio data and audio commands. The audio unit includes a microphone for acoustic input, an audio processor operably coupled to the microphone for converting the acoustic input into an electrical signal. The audio processor also provides for conversion of electrical signals into an acoustic signal. The audio unit also includes a speaker operably coupled to the audio processor for emitting acoustic signals. The action control module also includes a movement effecting device operably coupled to the processor. The movement effecting device provides movement of the action device. The action device is configured to detect a host device, at least a second or more action devices, or both.

A method for handling data in a buffer of an action device comprises receiving data at an action device from a host device through a first communication protocol. The method also includes providing a delta counter for counting bytes of data entering and leaving a buffer of the action device. Incrementing the delta counter for each byte of data entering the buffer and decrementing the delta counter for each byte of data leaving the buffer. The method includes determining whether a maximum threshold or a minimum threshold is met or surpassed; generating a throttle packet to change the rate at which data is entering the buffer; and sending the throttle packet to the host device using a second communication protocol.

A method of operating a networked system, the networked system defined by a host device and an action device, the method comprising providing a host device, the host device configured to bi-directionally send and receive wireless communications using a first communication protocol and a second communication protocol. The method also including providing an action device, the action device configured to bi-directionally send and receive wireless communications with the host device and establishing a thread between the host device and the action device. The method also includes sending one or more data files from the host device to the action device using the first communication protocol at an initial data transference rate. The method of operating a networked system further includes receiving a throttle control packet from the action device through the second communication protocol, and adjusting the data transference rate at the host device in response to the received throttle control packet. The throttle control packet contains a change to the initial data transference rate thereby creating a new data transference rate. The method also includes sending one or more data files to said action device at said new data transference rate.

A method comprising providing a first action device, the action device having an action control module attached therewith. The action control module including a transceiver for bi-directionally sending and receiving wireless communications using a first communication protocol and a second communication protocol, a processor electrically coupled to the transceiver. The processor provides data management of and for the action device, processing of wireless communications, and management of movement of the action device. The action control module also includes an audio unit operably coupled to the processor for sending and receiving audio data and audio commands. The audio unit includes a microphone for acoustic input, an audio processor operably coupled to the microphone for converting said acoustic input into an electrical signal, and the audio processor also provides for conversion of electrical signals into an acoustic signal. The audio unit further includes a speaker operably coupled to the audio processor for emitting acoustic signals. The action control module also includes a movement effecting device operably coupled to the processor. The movement effecting device provides movement of the action device. The first action device is configured to detect a host device, at least a second or more action devices, or both. The method further includes transmitting a broadcast-discovery packet via the second communication protocol.

### BRIEF DESCRIPTION OF THE DRAWINGS

FIG. 1 is an illustration of the networked system in a first operation mode, the networked system including a plurality of action devices.

FIG. 2 is an illustration of the networked system in a second operation mode, the networked system including a plurality of action devices.

FIG. 3A depicts a voice activated feature of the networked system in the second operation mode.

FIG. 3B shows a voice activated feature of the networked system in the first operation mode.

FIG. 4 shows one embodiment of action devices interacting with each other in a second operation mode.

FIG. 5 is a schematic of an action control module.

FIG. 6 illustrates an exemplary action device including an action control module.

FIG. 7 is a flow chart from the perspective of the action device depicting a sequence of actions executed by the action device.

FIG. 8A is a flow chart from the perspective of the host device depicting a sequence of actions executed by the host device.

FIG. 8B is a flow chart from the perspective of the action device depicting a sequence of actions executed by the action device.

FIG. 9 is a detailed flow chart of the delta management process employed by the action device.

### DETAILED DESCRIPTION

Before explaining at least one embodiment of the inventive concept(s) disclosed herein in detail, it is to be understood that the inventive concept(s) is not limited in its application to the details of construction and the arrangement of the components or steps or methodologies set forth in the following description or illustrated in the drawings. The inventive concept(s) disclosed herein is capable of being used in other embodiments or of being practiced or carried out in various ways. In addition, it is to be understood that the phraseology and terminology employed herein is for the purpose of description and should not be regarded as limiting.

In the following detailed description of embodiments of the disclosure, numerous specific details are set forth in order to provide a more thorough understanding of the inventive concept(s) disclosed herein. However, it will be apparent to one of ordinary skill in the art that the inventive concept(s) within the disclosure may be practiced without these specific details. In other instances, well-known features have not been described in detail to avoid unnecessarily complicating the description. The following detailed description refers to the accompanying drawings. The same reference numbers in different drawings may identify the same or similar elements.

The inventive concept(s) disclosed herein generally relates to a networked system defined by one or more action devices, and/or a host device and at least one action device. The networked system utilizes a unique hybrid of two communication protocols, and a delta management process that is an effective data management technique. The inventive networked system is also capable of operating in two modes of operation, a first operating mode, and a second operating mode. All these elements in conjunction provide for a robust and versatile networked system that is capable of being used in a variety of applications and fields.

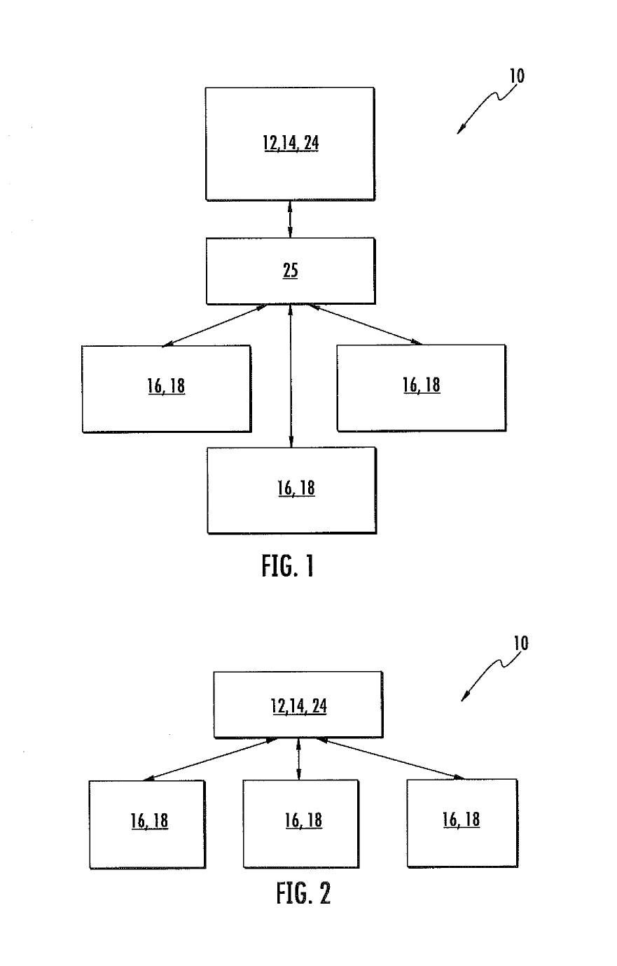

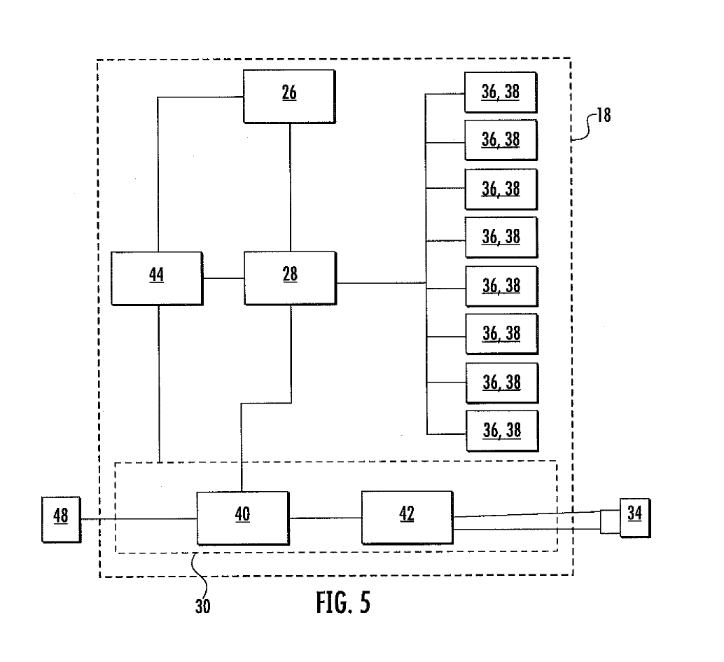

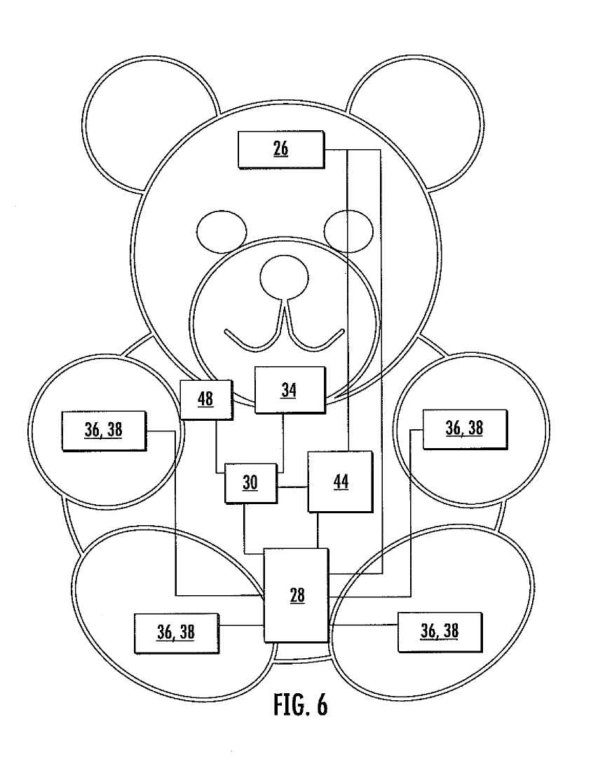

Referring generally to the figures, a networked system is illustrated and generally designated by the numeral 10. FIGS. 1-4 depict various embodiments and operation modes of networked system 10. Networked system 10 includes host device 12, host control application 14 operably associated with host device 12, at least one action device 16, action control module 18 embedded or carried by action device 16, and firmware (not depicted) operably associated with action control module 18. Content (not depicted) is electronically stored on host device 12, host control application 14, and/or action device 16. In other embodiments, networked system 10 includes at least one or more action devices 16.

Host device 12 includes transceiver 24 for bi-directionally sending and receiving wireless communications. As used herein, wireless communications includes currently existing wireless communications standards and communication protocols. For example, such wireless communication standards include wireless local area network (WLAN) described by the Institute of Electronic and Electrical Engineers (IEEE) 802.11 family of standards, variations, and successors thereof. Accordingly, transceiver 24 of host device 12 is an IEEE 802.11 transceiver. As will be discussed further, host device 12 is configured to also use the protocols of those established under the IEEE 802.3 family of standards and successors thereof, also commonly refereed to as Ethernet, to connect and operate with wired networks. Also, as used herein communication protocols include, but are not limited to, a first communication protocol and a second communication protocol. For example, the first communication protocol is the Transmission Control Protocol (TCP) of the Internet protocol suite, and the second communication protocol is the User Datagram Protocol (UDP) of the Internet protocol suite. Host device 12 is also connectable to wireless access point 25, for example, a router. It should be appreciated other communication protocols, whether or not yet in existence, having properties similar to those of TCP and UDP and capable of being used with the IEEE 802.11 family of standards and successors thereof are suitable and contemplated for use in networked system 10.

As known to those skilled in the art TCP is a streaming-based protocol that provides for the delivery of sequentially ordered streaming bytes to the specific receiver. TCP is optimized for accurate delivery rather than timely delivery. TCP ensures that the information is delivered in the order it was sent by providing a mechanism that acknowledges receipt of the information and signal for retransmission if the information is not received. TCP transmissions require two points of connection defined by the internet protocol (IP) address and port number. The host endpoint must have a unique IP address and port number while the device (client) must have a unique IP address and the same port number. UDP is designated as a “connectionless protocol” meaning that no endpoints are required, however, the port numbers must be the same. There is no guarantee that a UDP communication will be received by the targeted device and no confirmation that the targeted device received the communication. As will be discussed further, UDP lends itself to be utilized for the broadcast-discovery messaging of action device 16 and as communication method between action devices 16 and also between host device 12 and one or more action devices 16.

Networked system 10 has at least two different operating modes, a first operating mode and a second operating mode. The operating mode of networked system 10 means that all action devices 16 and/or host device 12 are in the same operating mode. In one embodiment, the two operating modes are based on the wireless communication standard utilized in networked system 10. As known to those skilled in the art, the IEEE 802.11 family of standards defines two operating modes: (a) Infrastructure Mode; and (b) Ad Hoc Mode. As used herein, the first operating mode is infrastructure mode and the second operating mode is ad hoc mode.

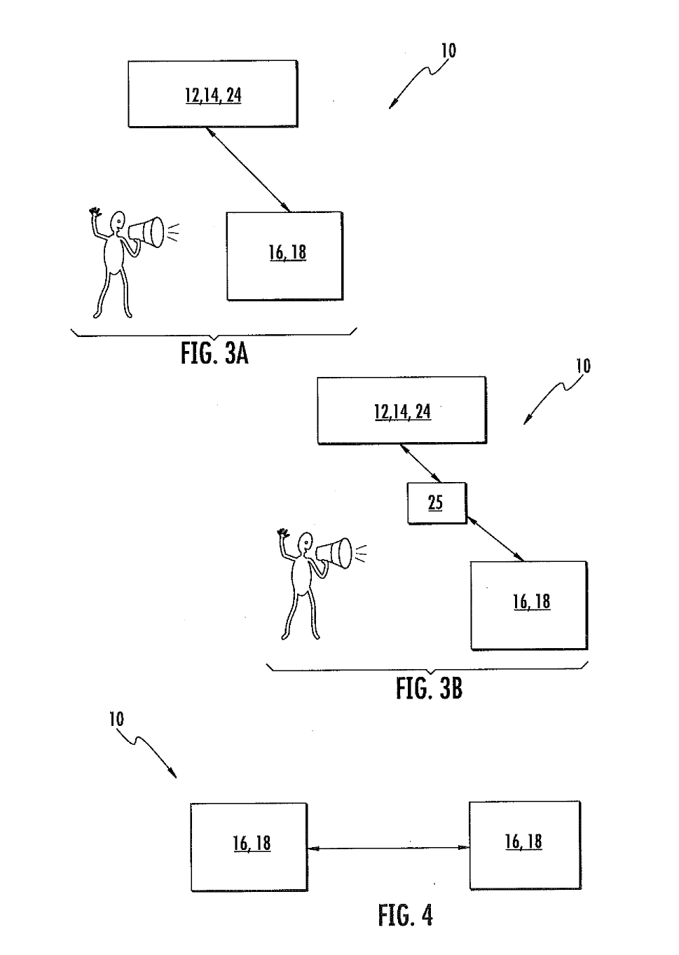

As known to those skilled in the art, infrastructure mode is a network framework provided by the IEEE 802.11 family of standards in which all communications between wireless clients are made with the help of access point 25, for example, those typically found in a home network, municipal, and/or commercial establishments offering wireless connectivity. In infrastructure mode, all connected devices connect to and communicate through the access point. Access point 25 can communicate with the internet via a modem, access to a telephone line, or local area network (LAN) using, for example, a LAN defined by the IEEE 802.3 family of standards and successors thereof FIGS. 1 and 3B illustrate various embodiments of networked system 10 in infrastructure mode.

In ad hoc mode in the 802.11 family of standards networking framework, devices communicate directly with each other without the use of an access point 25, this is also referred to as peer-to-peer mode. As known to those skilled in the art, ad hoc mode of WLAN devices allows the connection of devices that are in communication range. FIGS. 2, 3A, and 4 depict various embodiments of networked system 10 in ad hoc mode. For example, smart devices and other wireless devices using host control application 14 depict one embodiment facilitating the operation of networked system 10.

As previously stated, action device 16 includes an external switch designates or determine the operation mode of action device 16. Similarly, host device 12 contains a switch, either external or internal via software, which defines the operation mode of host device 12. Various methodologies for switching between ad hoc and infrastructure mode are known to those skilled art and will not be discussed further herein.

Host device 12 is a computer-based device such as, but not limited to a personal computer, including desktop, laptop, or netbook; or a smart device, including mobile phones and tablets. Any other device capable running host control application 14, and having wireless communication ability using the IEEE 802.11 family of standard, variations, and successors thereof, and the ability to utilize the first and second communication protocols is a suitable device to serve as host device 12. Host device 12 is capable of operating in two operating modes, a first operating mode, and a second operating mode. Host device 12 can be toggled between the two operating modes via an external switch, or internal switch (e.g. software), and other methods known in the art.

Host device 12 manages operation of action device 16. Host device 12 includes host control application 14. Host device 12, through host control application 14, provides command and control of each action device 16 in networked system 10. Host control application 14 also controls the timing and distribution of data or Content to each connected action device 16 via a wireless connection using the first communication protocol in a coordinated manner because Content contains the requisite information for host application 14 to carry out. Host control application 14 may also utilized the first and second communication protocols either at the same time or at different times to communicate with each action device 16. For embodiments having more than one action device 16 in networked system 10, host control application 14 has the ability to provide command and control over each action device 16 simultaneously and provides for distribution of Content to each device in a coordinated manner thereby providing for the implementation of Content by each action device 16 in a choreographed and coordinated operation. Host control application 14 can be customized to operate on any suitable host device 12 because host control application 14 can be written in a compatible programming and/or scripting language for various host devices 12 and their respective operating systems. Host control application 14 provides the above features without limitation to a particular type of application or version or programming language.

As used in this disclosure Content includes command, information, or an action to be carried out by action device 16. Content contains the requisite information for host control application 14 to carry out and provide command and control over each connected action device 16. Content includes information, such as but not limited to, the number of characters (or needed action devices 16, the tempo of the overall performance of networked system 10, the nonverbal and verbal commands for each character, and the timing and coordination for each character to implement the verbal and nonverbal ques. For example, Content can include system command data, audio data, or other information or data related to motions, actions, and timing thereof, of action device 16, and combinations thereof. Content comes in various forms depending on the embodiment of the current invention. For example, Content may be pre-defined and provided with purchase of networked system 10 components. Content may be obtained online or through other vendors, such as online or brick-and-mortar retail vendors, or may be user-generated. Content can also be stored in action device 16 via a memory card (not depicted). Examples of Content will be discussed in the various embodiments and applications of networked system 10.

Action device 16 is capable of operating in two operating modes, a first operating mode, and a second operating mode. Action device 16 can be toggled between the two operating modes via an external switch, or software, and other methods known in the art.

Action device 16 is configured to bi-directionally send and receive wireless communications and utilize at least the first and second communication protocols either at the same time or at different times. Depending on the embodiment, action device 16 is capable of independently receiving streaming commands via the first and second communication protocols from host device 12 or other action devices 16 in a choreographed or coordinated manner.

Action device 16 can also serve as a relay between host device 12 and other non-compatible, or tertiary, wireless devices if action device 16 is equipped with the capability of utilizing the communication protocols of the tertiary wireless devices. As used herein tertiary wireless devices are those devices not utilizing or compatible with the IEEE 802.11 family of standards and successors thereof Examples of tertiary wireless devices include devices using and compatible with the IEEE 802.15.4 family of standards and successors thereof, IEEE 802.15.1 family of standards and successors thereof, and other wireless systems. The communication protocols and/or standards for the tertiary wireless devices are selected from the group consisting of IEEE 802.15.4 and successors thereof, IEEE 802.15.1 and successors thereof, other wireless communication systems, and combinations thereof. By way of analogy, action device 16 is a translator between host device 12 and tertiary devices. Action device 16 has an action control module 18 embedded therein. It should be appreciated that action control module may also be carried by action device 16, including detachably coupled to and/or form an integral single component with action device 16.

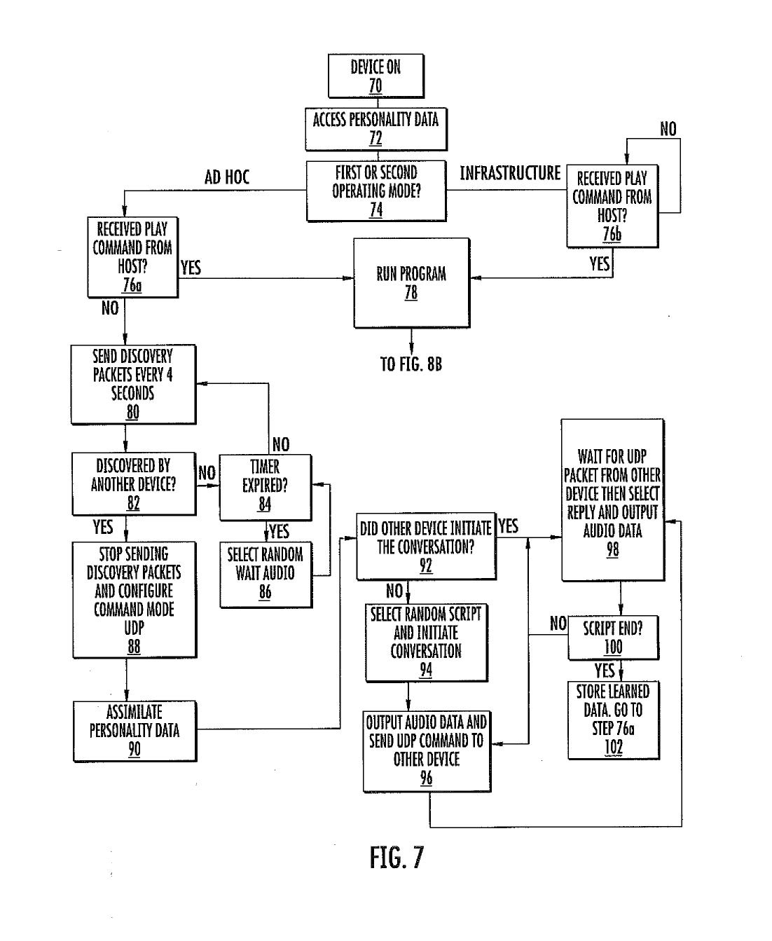

FIG. 5 depicts a schematic of action control module 18. Action control module 18 includes a compatible wireless transceiver 26, where transceiver 26 is connectable to the wireless transceiver 24 of host device 12 directly or through wireless access point 25. Wireless transceivers 24 and 26 are IEEE 802.11 transceivers or any transceiver providing equivalent functionality. Action control module 18 also includes processor 28 in electronic communication with transceiver 26. Processor 28 provides for processing and execution of received data or Content from host device 12, data management of action device 16, and manages operation of any other components attached to processor 28 via processor's 28 plurality of expansion ports 36, and/or input/output ports 38. Action control module 18 can include any number of expansion ports 36, or input/output ports 38 required to operate action device 16. Processor 28 can be, for example, a microcontroller.

Action control module 18 includes power source 44 providing power to transceiver 26, processor 28, optional audio unit 30, and/or any other devices or optional units utilizing expansion ports 36, or input/output ports 38. Power source 44 can be any source known in the art, including, but not limited to, battery power, wall power, solar power, and combinations thereof. Power source 44 includes one or more regulators (not depicted) to maintain consistent power supplied to the various components in action control module 18 requiring power. The details of power source 44 will not be described further as providing various power configurations is within the purview of those skilled in the art.

For example, a voltage of approximately 6.0 VDC (volts direct current) is used to power the various components in action control module 18. In the event wall power is used, for example in the United States 120 VAC (volts alternating current), 60 Hz (Hertz) or in other countries, for example, Europe, 220-250 VAC, 50 Hz, power source 44 will include the appropriate transformers to arrive at an output of approximately 6.0 VDC for action control module 18. It should be appreciated that the values provided herein are exemplary, and the any power level that provides for proper function of action control module 18 is suitable for networked system 10.

In the embodiment depicted in FIG. 5, action control module 18 includes audio unit 30. Audio unit 30 includes microphone 48, audio processor, 40, audio amplifier 42, and speaker 34. Audio unit 30 provides for the receipt of audible sound, processing thereof, as well as conversion of electrical signal into an audible sound. Audio unit 30 is in electronic communication with processor 28 and receives power from power supply 44. Audio unit 30 includes a microphone 48 for acoustic detection. Microphone 48 is operably coupled to audio processor 40. Audio processor 40 includes an audio codec, as known to those skilled in the art, which will convert the received analog audio input into a usable digital format, including compressed or uncompressed audio file format. The converted audio data will be forwarded to host device 12 via the first communication protocol for processing by host control application 16. Audio processor 40 is operably coupled to audio amplifier 42, which in turn is operably coupled to speaker 34 for emitting sound. The operation of audio unit 30, including receiving acoustic input, conversion of acoustic input to a digital format, encoding and decoding of acoustic or electronic signals, and conversion of a digital/electronic signal to acoustic output, and amplification thereof is known to those skilled in the art and the details of which will not be discussed further herein.

Audio processor 40 supports several audio file formats including uncompressed audio format and compressed file formats known in the art.

Other components that can be attached to action control module 18 via expansion ports 36 and/or input/output ports 38 include, but are not limited to, one or more: additional processors 28; memory cards; audio units 30; switches; buttons; devices providing the ability for movement, including servos, wheels, propellers, motors, and other mechanical, electro-mechanical devices; visual systems, including visual processors and/or visual displays, or touchscreens; sensors such as, but not limited to, microphones, other acoustic or sonic detection sensors or devices; vibration sensors; movement detection or measuring devices or sensors, including motion detection or accelerometers; contact sensors, including tactile, force, and collision; optical sensors; proximity sensors; position sensors; location sensors; presence sensors; environmental sensors, including, temperature, moisture, humidity, and pressure; orientation sensors, including gyroscopes; electromagnetic sensors; infrared sensors; gas detection sensors for detecting combustible, flammable, toxic gases, and/or oxygen depletion; radioactive detector sensors; magnetic field sensors; photoelectric sensors; radar sensors; sonar sensors; and other sensors known in the art. It should be appreciated that the sensors utilized will vary per application of the inventive networked system 10.

FIG. 6 depicts an exemplary embodiment of action device 16 with action control module 18 therein with the optional audio unit 30. It should be appreciated that in addition to audio unit 30, or in lieu of audio unit 30, expansion ports 36 and input/output ports 38 can be used for other functions and purposes.

The firmware stored within processor 28 manages the functionality of action device 16. The firmware also provides for control and management of incoming and outgoing data, as well as control and management of commands related to action device 16 using expansion ports 36, and input/output ports 38. As used herein, firmware suitable for managing the process of the current invention can be developed, written by, and/or compiled by anyone skilled in the art, as such further details relating to firmware will not be discussed in detail herein. Thus, the firmware provides for the above features without limitation to a particular type of firmware application or version or programming language.

For example, in embodiments including audio unit 30, the firmware is adapted to distinguish between audio data commands and system commands in Content received from host device 12 or other action devices 16. The firmware manages the audio data commands and communicates the audio data to audio processor 40, where the audio data commands are particular audio sound(s) to be emitted from speaker 34. System commands in Content include, but are not limited, causing processor 28 to read or take input from expansion ports 36 or input/output ports 38, and/or causing any other device attached to expansion ports 36 or input/output ports 38 to elicit an action. In the case a servo is attached, system commands may cause servo to actuate thereby moving action device 16 in a manner that may be synchronized with an audio command such that the movement of servo and the emission of audio from speaker 34 occur simultaneously. It should be appreciated that the timing of the execution of the system commands and the audio data command may not be synchronized. It should further be appreciated that Content contains command and other data for execution or performance by of action device 16 to be carried out in a choreographed manner.

The firmware manages incoming data (or Content) from host device 12 and from other action devices 16, and other sources through expansion ports 36, and input/output ports 28.

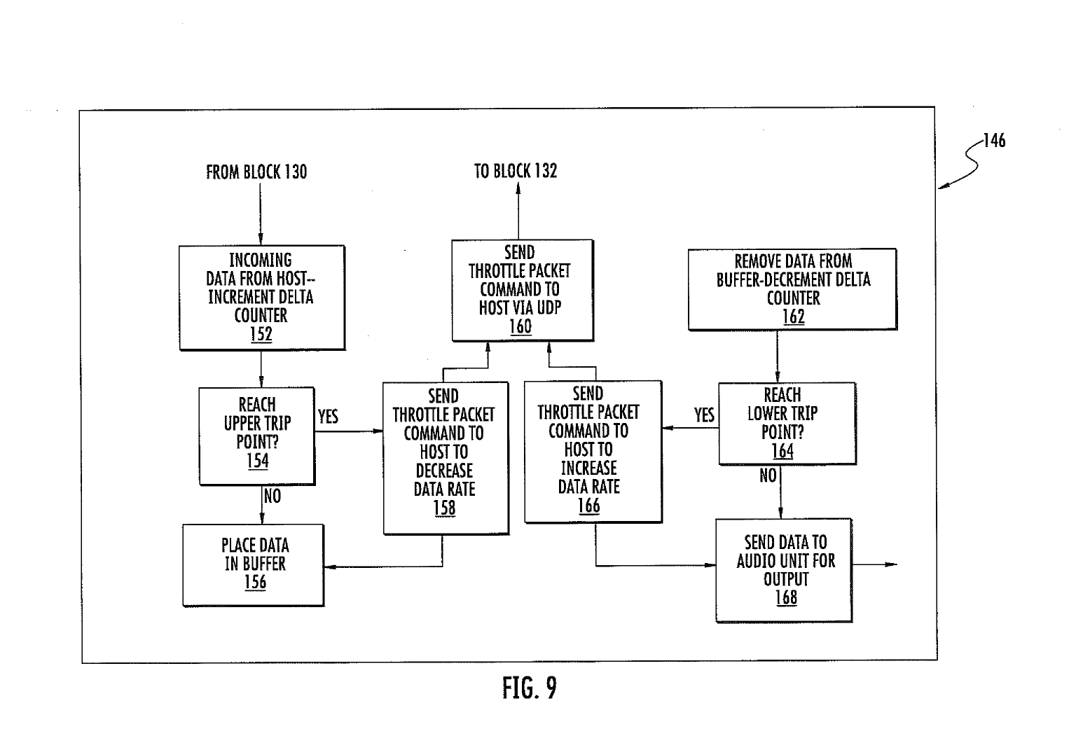

In one embodiment, a buffer in processor 28 handles data incoming from host device 12 via the first communication protocol. It should be appreciated that a buffer is also used by processor 28 for handling communications between action devices 16. The data handling within the buffer for networked system 10 will be more fully discussed regarding FIG. 9. As known to those skilled in the art, buffers are often used when there is a difference between the rate at which data is received and the rate at which data can be processed, meaning that the rates are variable. As known to those skilled in the art, the use of a circular buffer programming technique is one general standard approach known in the art to manage data. The circular buffer programming technique uses at least two pointers. One pointer, or address of a cell, within the circular buffer, for incoming data, and another pointer for outgoing data. The buffer is empty when both pointers point to the same cell. The standard way of managing data in the circular buffer is to manipulate the pointers by calculating the difference between the pointers and ensuring the buffer is not overrun (when the pointer for incoming data goes past the pointer for outgoing data), thereby losing any incoming data. A current technique to avoid overruns is to define larger buffers. In devices, such as processor 28 where memory is limited, defining larger buffers is not a viable option, such practice provides for inefficient use of processor 28.

The firmware utilizes a new and unique buffer technique referred to as “delta management” to manage data in a buffer. For implementation of the delta management technique, the size of the buffer is known. The delta management process does not perform calculations of the pointers. Performing calculations on pointers decreases the amount of processor time spent on performing other tasks because the processor must devote valuable time and resources to managing the buffer. The delta management technique uses a delta counter to count the incoming/outgoing bytes of data entering/leaving the buffer thereby allowing processor to devote valuable time and resources to performing other tasks. The delta management technique monitors the delta counter against the size of the buffer. Since the size of the buffer is known, throttle or trip points can be set. For example, an upper or maximum threshold or trip point can be defined such that when the delta counter exceeds the upper threshold, a throttle packet command can be sent via the second communication protocol to host device 12 to decrease the rate of incoming data. Similarly, a lower/minimum threshold or trip point can be defined such that when the delta counter drops below the lower threshold, a throttle packet command can be sent via the second communication protocol to host device 12 to increase the rate of incoming data. The throttle command packet will also contain how many microseconds to increase or decrease the incoming data rate from host device 12.

The delta management process can be thought of as a valve, when there is too much incoming flow (e.g. data) that will overfill the container (e.g. buffer), the delta management system determines that the valve needs to be closed by some margin (i.e. slow or even stop the incoming data). Similarly, when there is too little incoming flow, and the container has the capacity to handle more, the delta management system determines that the valve needs to be opened by some margin (i.e. increasing the incoming data rate). The delta management process will be further discussed during the discussion of exemplary embodiment in relation to FIG. 9.

A general discussion of each component of networked system 10 has been provided above. The following discussion will focus on the figures and elaborate on the various embodiments and functionality of each component within networked system 10. For purposes of the following discussion, networked system 10 will be in the context of an entertainment embodiment, for example, a toy. The toy embodiment utilizes the inventive concepts discussed above to create an entertainment system capable of a performance (e.g. storytelling, voice recognition) through a variety of different audio, audio/visual, and/or audio-electromechanical (e.g. movement and/or posturing) actions thereby providing the observers of the networked system 10 an enjoyable and interactive experience. As will be discussed below, the inventive system is adaptable. Content of the toy embodiment can be modified in order to maintain the interest of the observer and/or owner as the age, personal tastes, and preferences of the observer and/or owner change over time.

FIG. 1 depicts networked system 10 in a first operating mode, for example infrastructure mode. In this embodiment, networked system includes host device 12, access point 25, and a plurality of action devices 16. In this embodiment, communications between host device 12 and action devices 16 are achieved through hybrid use of the first and second communication protocols, for example TCP and UDP, respectively. As depicted, communications between host device 12 and action devices 16 occur through access point 25. In this embodiment, if additional Content is desired, Content may be available for distribution and/or purchase through the internet or other retail locations.

FIG. 2 depicts networked system 10 in a second operating mode, for example, ad hoc mode. In this embodiment, communications between host device 12 and action devices 16 are achieved through hybrid use of the first and second communication protocols, for example TCP and UDP, respectively. Thus, host device 12 and action devices 16 do communicate through access point 25.

Turning to FIGS. 1 and 2, a user desiring to initiate a performance, for example, a story, will launch host control application 14 on host device 12 and select the desired Content. Additionally, the desired number of action devices 16 must also be turned on. It should be appreciated that the order in which host control application 14 is launched with respect to the powering one of action device 16 is immaterial. As previously discussed, the operation mode of host device 12 and action device 16 must match in networked system 10.

After a user selects the desired Content and initiates the process for execution of the desired Content (e.g. pressing PLAY or RUN PROGRAM or START), host device 12 and action device 16 will establish a host/client relationship. As known to those skilled in the art, in the first operation mode (e.g. infrastructure mode), access point 25 is an IEEE 802.11 router and will broadcast a set service identifier (SSID) for all action devices 16 within range to associate (link) with that specific access point 25. Action devices 16 via the firmware will send out broadcast-discovery packets under the second communication protocol (e.g. UDP) using transceiver 26 (e.g. an IEEE 802.11 transceiver). Upon discovery, host device 12, through host control application 14 and its IEEE 802.11 transceiver 24, derives the internet protocol (IP) address of action device 16 from the emitted broadcast-discovery packet. After host device 12 derives the IP address of action device 16, a valid TCP connection is formed between host device 12 and each device 16 with host device serving as host and action device serving as the client. If networked system 10 is in the second operation mode (e.g. ad hoc mode), the same process will occur as previously described for the first operation mode except access point 25 will not be included and actions devices 16 will link directly with host device 12.

Content contains all the information required for host control application 14 and action device 16 to complete the desired performance. For example, if Content is a story, Content will contain the required number of actors, the characteristics of the actor, for example, gender (male or female), age (child, adult), species (human, animal, extraterrestrial). As a result, each action device 16 portrays each actor using a unique voice. Content also contains the timing or tempo of the story, the synchronization of physical actions to occur with audio or to occur at other times, and all the voice or sound files that will be used by each actor. In the event there are more characters than there are action devices 16, one or more action devices 16 will perform multiple character roles. In the event there are more action devices 16 than there are characters, the unused action devices will remain dormant during the story because they will not receive a PLAY command. A command may be sent for the unused action devices 16 to conserve power and go into a sleep mode. As a result, networked system 10 allows for action devices 16 to speak or perform functions in sequence or simultaneously.

Content can take multiple forms including, stories, songs, poems, portions of sentences or words, partial or complete dialogs, etc. As previously discussed, Content can be acquired in multiple ways, including, but not limited to, purchase of the components for networked system 10, downloading Content through either host device 12 or action control module 16, or installation of Content on host device 12 through physical storage mediums such as, disks, compact discs (C.D.s), USB flash drives, and user created Content through the use of compatible software utilities. For example, user created Content can include a family member reading and recording a story or other audible sounds to be performed later by networked system 10.

Host device 12 also manages parameters of action device 16, including, but not limited to, volume; treble/bass; audio effects, including, but not limited to, echo, reverb, mixing, modulation, pitch shifting, and flanging; personality traits, including age, gender, philosophy, and disposition; identification; specific memory and learning references; hardware adjustments; sensor adjustments; and firmware updates. Based on user preferences, a user can also set parameters in host control application 14 for each action device 16, such that each action device 16, having a unique identification number, will only connect with the specific host device 12, or vice versa—that host device 12 will attempt to only connect with the specific action devices 16 identified by the user, even if other action devices 16 are within range.

The range of wireless communications under the IEEE 802.11 family of standards is currently about 300 feet, assuming no obstruction of the wireless signal. The number of action devices 16 that can connect with a single host device 12 is about two hundred and fifty-four (254) action devices 16. For practical considerations due to the limitations of current existing technology in processor 28, approximately up to thirty-two (32) action devices 16 may be connected at the same time to a single host device 12 when operating in the first operation mode. Due to the same limitations on processor technology, it is preferable to limit simultaneous connection to up to seven (7) action devices 16 when operating in the second operation mode, however modifications to the IEEE 802.11 network can be made to accommodate mode than seven (7) action devices 16. Such modifications are within the purview of those skilled in the art and will not be discussed. As technology for processor 28 advances, the number of connected action devices 16 to a single host device 12 will increase.

Personality data is contained on a memory card that is connected to processor 28. Suitable memory cards include those known in the art, such as, but not limited to mini-sized memory cards, micro-sized memory cards, and any memory card suitable for fitting within and compatible with action control module 18. The memory card can contain data that defines gender, approximate age, personality traits, physical limitations, philosophy, education, statistical tendencies (based on conservative or liberal leanings), and other types of likes and dislikes. The statistical tendencies will affect the decision making process and the form of language or choice of words and/or phrases used by action device 16 to exhibit a personality. In addition, the memory card contains pre-recorded character voices (as defined by some of the personality definitions). It should be appreciated that depending on the end-application, personality data can be modified to be used as guidelines rather than determinate data, thus allowing action device 16 to create self-determining boundaries and maintain self-preservation.

FIG. 7 depicts a block diagram from the perspective of action device 16 in operation. Starting at block 70, action device 70 is turned on by a user. As previously discussed, action device 16 may be turned on via an external switch, button, remote, etc. and may be battery operated or receive power from a wall source. At block 72, action device 16 will access personality data contained within memory card attached to one or more of expansion ports 36 or input/output ports 38 of processor 28. Action device 16 has a default personality and character that may be changed by a user through manipulation of parameters through host device 12, as previously discussed. At block 74, processor 28 will determine the mode of operation action device 16 is currently in. As previously discussed, the mode of operation can be toggled between by an external switch, remote control, or other methodologies. To change between the first and second modes of operation, action device 16 will need to be restarted, meaning powered off and powered back on, after operation modes are changed. Action device 16 will proceed to block 76b if action device is in the first operation mode (e.g. infrastructure mode). Action device 16 will proceed to block 76a if action device 16 is in the second operation mode (e.g. ad hoc mode). At block 76b, action device 16 will wait until a PLAY command is received from host device 12. Again, action device 16 and host device 12 must be in the same mode of operation. After a pre-determined time of not receiving a PLAY command from host device 12, action device 16 is configured via the firmware to go into a sleep mode to conserve power. At blocks 76a and 76b, if action device 16 receives a PLAY command from host device 12 (which is in the same operation mode as action device 16), meaning a user initiated or started Content, the flow process will proceed to block 78.

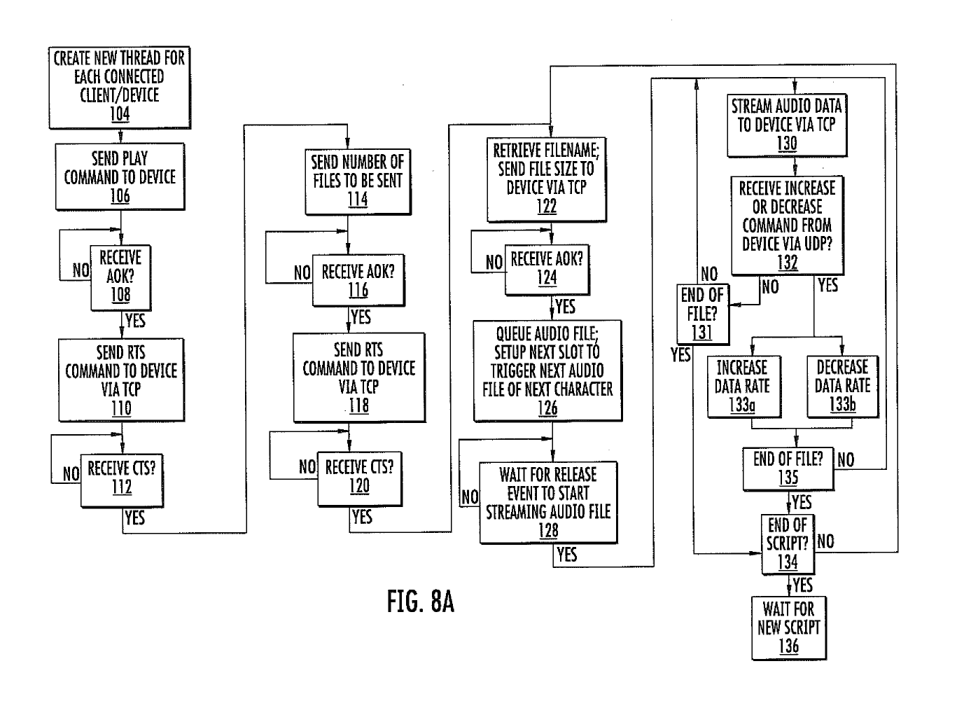

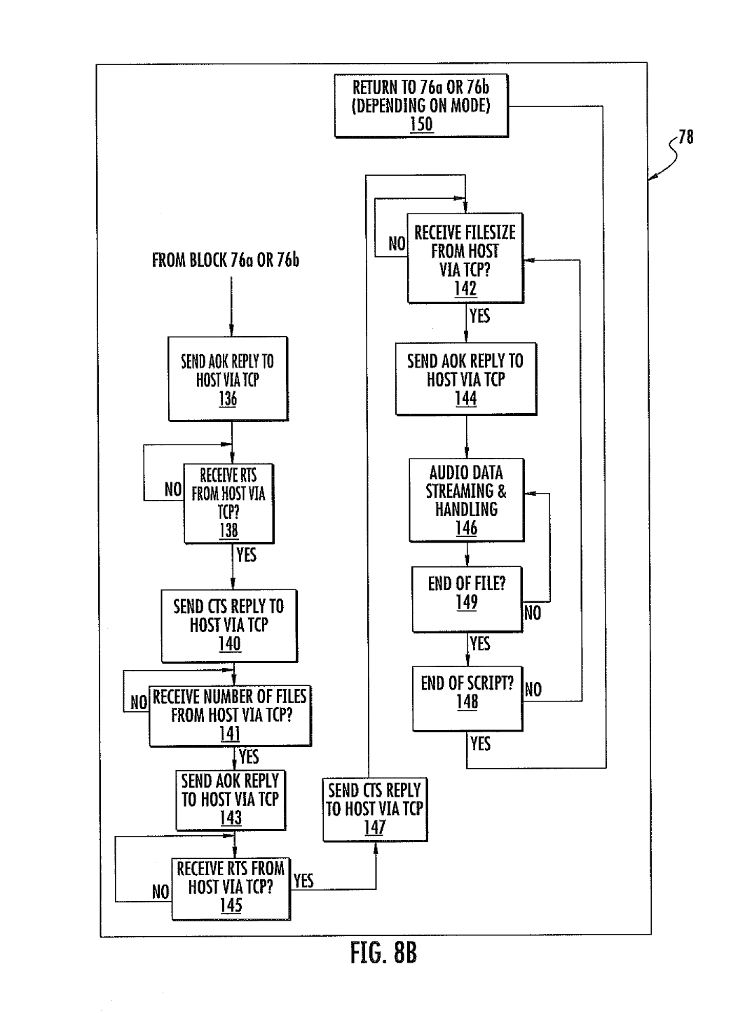

FIGS. 8A and 8B illustrate the steps occurring from the perspective of host device 12 and action device 16, respectively, after a user initiates Content. In particular, FIG. 8B depicts the steps occurring in box 78 depicted in FIG. 7. The following discussion will refer to both FIGS. 8A and 8B.

Networked system 10 utilizes both the first and second communication protocols in a unique hybrid approach. Starting with block 104 in FIG. 8A, when a user initiates Content, host device 12 will create a new thread for each connected action device 16 regardless of whether the specific action device 16 is needed for the execution of the Content. Creating a unique thread between host device 12 and each connected action device 16 allows for the unneeded action devices 16 to remain dormant and not interrupt if the specific action device 16 does not receive a PLAY command from host device 12. Each thread runs asynchronously, thus providing robustness for networked system 10 by allowing for host device 12 to manage multiple action devices 16 simultaneously. The use of a unique thread for each action device 16 allows host device 12 to control action devices synchronously or asynchronously. As previously discussed, host device 12 and action device 16 will create a formal connection. In particular, the type of connection between host device 12 and action device 16 utilizes thin-client architecture known to those in the art. Utilizing the thin-client architecture, removes the processing burden off processor 28 and places the processing burden as much as possible on host control application 14. As a result, host control application 14 is able to process and manage more complex and involved sub-applications, including, but not limited to, voice recognition (discussed below), machine learning, language translation (internationalization), and maintaining a personality database for each action device 16.

At block 108 in FIG. 8A, host device 12 through host control application 14 and transceiver 24, will send the PLAY or START command via the first communication protocol to each connected action device 16. Host device 16 will then proceed to block 108 and wait for the acknowledgement or AOK from each connected action device 16. As shown in FIG. 8B, each action device 16 will send an AOK reply to host device 12 via the first communication protocol (e.g. TCP) in box 136 to acknowledge receipt of the PLAY command. The logic for action device 16 will proceed to box 138 where each action device 16 awaits a “request to send” (RTS) flow control signal from host device 12 via TCP. Referring back to FIG. 8A, at block 110, host device 12 will send each connected action device 16 the RTS and then move onto block 112 where host device 12 will await each connected action device's 16 “clear to send” (CTS) response via TCP. The corresponding block in FIG. 8B in response to box 110 is 140. The mechanism and function of IEEE 802.11 RTS/CTS is within the purview of those skilled in the art and will not be discussed in detail herein.

At block 114, host device 12 will send to each connected action device 16 the number of files that will be sent to the respective action device 16 via TCP. Host device 12 will then proceed to block 116 awaiting the AOK response via TCP from each action device 16 after each action device 16 receives the number of files from host device 12 (blocks 141 and 143 in FIG. 8B). At block 118, host device 12 will send a RTS command to each action device; this corresponds to block 145 from the perspective of each action device 16. Each action device will send a CTS reply via TCP in block 147 to host device 12. After host device 12 receives the CTS from the respective action device 16 at block 120, host device 12 will then retrieve the filename from Content, and send the file size to action device 16 as depicted in block 122 and then proceed to wait for action device's AOK reply at block 124. Recall that Content contains multiple files therein. After receipt of the file size from host device 12 via TCP at block 142, action device will send an AOK reply to host at block 144.

At block 126 in FIG. 8A, host device will queue up the appropriate audio and/or audio and command file for each connected action device and set up the next slot to trigger the next audio file of the next character (e.g. next action device 16). An analogy to this step is the starting gate used in horseracing. This analogy will also be referred to as event-control gates or event driven controlled gates, meaning that when a given event occurs, control gates will be opened or shut. In the case of networked system 10, each stall in the starting gate corresponds to a thread between host device 12 and a particular action device 16. Host device 12 will retrieve the audio files for each action device 16 and place the appropriate file within that particular action device's 16 queue. At block 128, host device will wait for the release event to start streaming the file via TCP to the particular action device 16. The release event for each action device 16 can vary depending on the timing defined in the Content. When the release event occurs, host device 12 will begin streaming the audio and/or system command data to the intended action device 16 at block 130 via TCP (e.g. opening the control gate). In FIG. 8B, each action device 16 will receive the streaming data and perform its own data handling and management in block 146.

As previously stated, host device 12 is capable of asynchronous simultaneous control of multiple action devices 16. Referring back to the horseracing starting gate analogy, this means that at block 130, host device 12 will open the appropriate gate(s) to send the data (e.g. files including commands, such as audio and/or system commands) to the intended action device(s) 16. Not all gates will open at the same time because the event triggering the release of the data may occur at different times and/or is dependent up the data transference rate for the individual action device 16.

From block 130, host control application 14 of host device 12 will proceed to block 132 where a check is made if a command from each connected action device 16 sent a throttle command via the second communication protocol (e.g. UDP). If no throttle command is received, host device will continue to stream the audio and/or command file to action device 16 at the current data transfer rate until the end of the file is reached, as depicted by block 131. If the answer to block 131 is in the affirmative, meaning the end of file is reached, host device 12 will then move to block 134 to check if the end of Content is reached.

In FIG. 8A, the end of Content is represented by block 134, the end of script. As used in the toy embodiment, Content and script are interchangeable. As described herein, the term script or Content is akin to scripts or screenplays for a theatrical performances where each character's verbal and nonverbal actions, and stage positions are set forth.

If a throttle command is received at host device 12 by the second communication protocol at block 132, the data transference rate will either be increased (block 133a) or decreased (block 133b). The throttle command sent from action device 16 will include the requested rate of increase or decrease. Host device 12 will adjust the data transference rate accordingly and then will move to block 135 to check if the end of the file is reached. If the answer is in the negative, the logic will move to block 130 to continue to stream the remainder of the file at the new rate or until another throttle command is received. If the answer to block 135 is in the affirmative, then the logic continues to block 134, and data, if applicable, will be streamed at the new requested rate.

If the answer to block 134 is in the affirmative, host device 12 will wait until a new script (or Content) is selected and initiated. The corresponding step in action device 16 is block 148. If the script is over, then depending on the operation mode of action device 16, the logic in action device 16 will return either to block 76a or 76b in FIG. 7. If answer to block 134 is in the negative, the logic of host control application 14 will move to block 122 to retrieve the next filename and file size to send to action device 16, In FIG. 8B, if the end of the file is reach in block 149 but the end of the script is not reached in block 148, then the logic for action device 16 moves back to block 142.

Turning back to FIG. 8B block 146, each action device utilizes the delta management system discussed previously to ensure that data from host device 12 is not lost. FIG. 9 illustrates the unique delta management process to manage data in a buffer in processor 28. Delta management works with large volumes of incoming data. The delta management technique uses a delta counter to count the incoming and outgoing bytes of data enter and leaving the buffer, respectively. As shown in FIG. 9 at block 152, the delta counter is incremented for each byte of data incoming/received from host device 12 (block 130). As previously discussed, the size of the buffer is known and upper and lower trip points are predefined for the given application of networked system 10. At block 154, a check is made to see if the upper trip point is reached or surpassed. If the answer to block 154 is in the negative, the data is placed in the buffer as depicted by block 156. If the answer to block 154 is in the affirmative, a throttle packet to decrease the data transference rate (the incoming data rate) from host device 12 will be generated. The data will still be placed in the buffer as shown by block 156. In addition, the generated throttle packet will be sent to host device 12 via the second communication protocol at block 160. The throttle command will include the specific change to the data rate. In other words, the throttle command will inform host device 12 by how much to change the data transference rate. Such indication can be made by indicating by how many microseconds to change the data rate.

As data is entering the buffer in FIG. 9, data is also being removed from the buffer at the same time. At block 162, the delta counter is decremented for each byte of data leaving the buffer. Data is removed from the buffer and sent to the appropriate unit or other device electrically or otherwise operably coupled to expansion port 36 and/or output port of input/output port 38. At block 164, a check is made if a lower threshold is met or exceeded. If the answer is in the affirmative, a throttle packet to increase the data rate will be generated in block 166. At block 160, the throttle packet command to increase the data transference rate will be sent to host device 12 at block 132 using the second communication protocol.

From block 166 or from a negative in block 164, the data will be removed from the buffer and sent to the appropriate unit or other device electrically or otherwise operably coupled to expansion port 36 and/or output port of input/output port 38 as indicated in block 168. For example, in the toy embodiment, if the data is audio data, the audio data will be forwarded to audio unit 30 for processing and handling via audio processor 40 and audio amplifier 42 and output through speaker 34.

In one embodiment, the ratio of data input into the buffer to data leaving the buffer is about 5:1 to about 3:1, and all ratios therebetween, including a ratio of about 4:1. For example, audio data is received and input into the buffer at a rate of about 15,000 bytes/second (B/s) and the outgoing data rate from the buffer is about 3,000 to about 5,000 bytes/second. Processor 28 has about 8 kilobytes (kB) of memory. For current applications using circular buffers, only 4 kB of memory of processor 28 can be dedicated for a circular buffer, thus leaving about half of processor's 28 memory for other functions. The standard approach of using a circular buffer, as discussed above, will not maintain the necessary data transference rate, whereas the delta management process as described herein, can sustain the higher and variable data rates. The delta management process is expected to use about 2.0 kB of processor memory for the buffer, thus leaving about 6.0 kB of memory for other functions.

For simplicity, the flow charts in FIGS. 8A, 8B, and 9 depict audio data. It should be appreciated that other data is being streamed by host device 12 to each action device 16. As previously discussed, such other data includes system commands, such as movements for action device 16 to execute either concurrently or non-concurrently with the audio output. Other data can also include commands to take readings or input from attached sensors and transmit the readings back to host device 12 using the first and second communication protocols.

The delta management process described above is not limited to management of the rates of data, but also is used to coordinate when the data received from host device 12 is to be used. Delta management helps with the coordination and choreography of networked system 10 because the incoming data from host device 12 also contains timing for when action device 16 is to execute that particular piece of data. Not all data has to be utilized in real-time (immediately upon receipt) and in order to coordinate motion with audio or other actions, for example, host device 12 may also data in a piecemeal manner to action device 16 to be processed and stored by processor 28 until all pieces are received at action device 16 and thus ready for execution.

In light of the prior discussions regarding data handling by host device 12 and action device 16, FIGS. 3A and 3B depict another feature of networked system 10. FIGS. 3A and 3B illustrate a voice recognition feature of networked system 10 in a second operation mode (e.g. ad hoc mode) and first operation mode (e.g. infrastructure mode), respectively.

For simplicity, only one action device 16 is depicted in FIGS. 3A and 3B; however, multiple action devices 16 may be used. As previously demonstrated, audio processing is intensive and taxing on a processor with limited memory. Similarly, voice recognition (or voice activation) is a form of audio processing. As previously discussed, networked system 10 utilizes thin-client architecture such that host control application 14 handles processor intensive functions. One or more users will talk to action device 16 as depicted in FIGS. 3A and 3B. Action device 16, through processor 28 and transceiver 26, will pass the raw, or compressed, audio input from audio unit 30 to host device 12 using the first communication protocol (e.g. TCP). Host device 12 through its transceiver and host control application 14 will receive and process the audio data received from action device 16. Host device 12 will then select the appropriate response to the audio data from the human speaker. Using the first communication protocol, host device 12 will send the appropriate response, including audio and/or physical movement, to action device 16 for action device 16 to carry out. The logic discussed regarding FIGS. 8A, 8B, and 9 is still applicable in the voice recognition feature. As depicted in FIGS. 3A and 3B, networked system 10 includes a host device 12 and at least one action device 16 operating is the same operation mode. The voice recognition feature provides for an interactive experience for the user and/or observer with networked system 10. The voice recognition feature also provides for varied usage of networked system 10.

The versatility of applications and uses of networked system 10 and action device 16 as illustrated in FIG. 7. In the context of the toy embodiment, if action device 16 is in the second operation mode (e.g. ad-hoc mode) and a PLAY command from host device 12 is not received because action device 16 is not connected to (or associated with) host device 12; action device 16 contains logic to give the appearance to an observer that action device 16 has a personality and is capable of passing the time and/or “entertaining” itself Action device 16 may “entertain” itself until another action device 16 comes within range (e.g. becomes aware of another action device 16); a host control application 14 comes online and Content is initiated; or to preserve power, action device 16 may go into a sleep mode. As will be described with relation to FIG. 7, this process will be referred to as the Self-Aware process.

If the answer at block 76a is in the negative, and action device 16 has an adequate supply of power and is not associated with a host device 12, as determined by logic and thresholds within firmware, action device 16 will begin sending broadcast-discovery packets via the second communication protocol every four (4) seconds, as shown by block 80. It should be appreciated that the rate for transmitting broadcast-discovery packets can be changed for the particular end application of action device 16 and networked system 10.

At block 82, if another device is not discovered, or if the action device 16 does not discover another device, then the logic moves to block 84 where a check of a timer is made. This timer relates to the time for discovery of a second action device 16. If the timer is expired, then a random Content (or script) stored on a memory card operably coupled to processor 28 is retrieved and performed and the time is reset. Random Content can include, but is not limited to, action device 16 singing, humming, and/or talking to itself, as well as moving. From box 86, after the completion of Content, the timer is checked again, recall that the timer was reset when the random Content was initiated. If the timer is not expired, action device 16 will transmit broadcast-discovery packets via UDP as shown in block 80.

If another device is discovered in block 82, the logic moves to block 88 where each action device 16 through logic contained on the firmware, will stop transmitting discovery packets and will go into command mode, meaning that each action device 16 will transmit command and control packets via UDP instead of broadcast-discovery packets. To establish a link between devices, the first action device 16, referred to as the initiating action device 16 will send out the SSID via the transceiver 26. Subsequent action devices 16 will associate (link) with that specific SSID. These action devices 16 will send out broadcast-discovery packets to the initiating action device 16 via UDP. Once discovered, the initiating action device 16 will derive an IP address and will form a valid TCP connection to the second action device(s) 16.

At block 90, each action device will assimilate their personality data. In this step, each action device calculates how the specific action device's character should proceed. In the toy embodiment, each action device 16 is equipped with multiple personalities or characters and voices that a user or owner may manipulate and/or select a default character.

In the character calculation, character traits are given a numerical weighting, similar to those used in neural networks. For example, each major trait is given an initial weighting (for example, 1 being the lower extreme and 100 being the upper extreme). As such, “aggressiveness” may have a weighting of 80 (very aggressive) or 10 (little or no aggression). Where each major trait is given an initial value, so is each sub-trait such as “current mood”, etc. The sub-traits will skew the major trait weightings up or down depending on its value. Examples of major traits include, but are not limited to gender, approximate age, personality traits physical limitations, philosophy, education, statistical “tendencies”. Examples of sub-traits include, but are not limited to number of siblings, social adeptness, relationship with others, including family, performance in school or sports. In addition, traits such as gender and age will determine the categories of initial Content choices and response choices of each action device. Subsequent progression of each action device's 16 dialog may be affected by the value of the major traits and sub-traits. The actual final values will assist in indexing a set of rules in a custom artificial intelligence engine in the firmware that is used to determine the personality of each character. Each personality can be changed or modified by the introduction of another character (e.g. interactions with one or more other action device 16) as well as manually adjusted by the owner or user of action device 16 through use of the host control application 14. The user can change these traits for each character. By modifying the character, host application 14 will send commands to action device 16 to modify its personality data. Such a change allows for the character to evolve and either mature or regress.

At block 92, a determination is made by each action device regarding which action device 16 initiated the conversation (made the discovery of at least one additional action device 16, i.e. second action device 16). The action device 16 that discovers the second action device is referred to as the initiating action device. With reference to FIG. 7, initiating action device 16 will proceed to block 94 and select a random script/Content-based on the assimilated personality data. When initiating action device 16 outputs its audio data and/or other movements at block 96, initiating action device 16 will send a UDP command to the second action device 16 informing the second action device 16 of the substance the initiating action device's 16 most recent output.

At block 98, the second action device 16 will wait for the UDP command from the initiating action device 16 containing the substance of the most recent output. Second action device 16 will then select the appropriate reply, output the reply, and send the substance of its reply via a UDP command to initiating action device 16. A check will then be made to determine if the script/Content has ended at block 100. If the script is not over, the logic for the initiating action device will return to block 96 and the logic for the device that did not initiate the conversation will return to block 98. If the answer to block 100 is in the affirmative, each action device 16 will store any learned data and the logic will proceed to block 76a.

Learning is achieved through interactions between action devices 16. As each character interacts with other characters, action device 16 will update and save its own data and experiences to the memory card operably associated with processor 28 for future use. The learned data affects the character calculation discussed above. The next time the particular character is used, the learned data is available for use, thereby providing an evolving personality for the particular character.

As discussed above, the one or more action devices 16 present the illusion of having an actual, intelligent conversation by asking and answering questions, playing word games, having sing-alongs, etc. If a third or fourth action device 16 becomes available, the first two action devices will adjust the conversation and games to include the newly joined action device(s) 16. For the toy embodiment, and for practical limitations of processor 28, it is preferred that up to seven (7) action devices 16 can connect in the Self-Aware process.

For example, if there are one or more action devices 16 within a local coffee shop or other public venue, and all action devices 16 are turned on and in the second operation mode, depending on the personality data of each action device 16, it is possible that the Self-aware process will initiate and cause one or more of the action devices 16 to communicate with each other.

The Self-Aware process has been discussed in the context of the toy embodiment, it should be appreciated that the self-aware process can be modified based on the end use of action device 16 and/or networked system 10. Thus the learning function and personality data is not necessarily an unchanging set of rules governing action device's 16 artificial intelligence engine; rather, the learning function and personality data may be used as guidelines. Further, learning is not limited to interaction with other action devices, learning may be achieved through environmental factors, for example, by action device 16 taking data input from the environment and surroundings of action device 16.

It should be appreciated networked system 10 can be used within the confines of a home or other building, or in a public place, such as a park, restaurant, airplane, at the beach, or other venues.

Example Applications of Networked System

The following descriptions provide examples of various used of the inventive networked system 10. The general functionality of networked system 10 is not altered by these embodiments. It should be appreciated that the flow charts previously discussed may change to accommodate the desired goal, and/or including more or less attached sensors or devices for each individual embodiment. However, the previously discussed functionality and logic utilized in networked system 10 is not changed, and thus will not be discussed again.

Location Based Entertainment

An interactive toy networked system has previously been discussed. This embodiment is not limited to household or private entertainment but can be applied on a larger scale, such as in the context of location based entertainment (LBE). LBE includes public facilities including, but not limited to, amusement, theme, or water parks; restaurants; museums; family entertainment centers; zoos; movie and live performance theaters; and other public venues.

The previously discussed network configurations and functionality of an LBE networked system is the same as that for the previously discussed toy embodiment. For example, action devices in the LBE embodiment may be the size of a child, adult, and/or larger. Like the toy embodiment, action devices in the LBE embodiment may be in bipedal or quadrupedal form or achieve movement by other means, e.g. flight or sliding. Each action device is capable of movement, speaking, and posturing within the context of the environment. Like the toy embodiment, a single host device manages all action devices in the LBE embodiment.

Animal Training and Animal Entertainment

Another use of networked system 10 includes animal training or defining an animal's boundary. FIGS. 1-4 are applicable networked system 10 configurations, with the networked system 10 configurations of FIGS. 1, 2, 3A, and 3B being preferred. This embodiment allows multiple animals to be trained and/or confined by the same boundary with the use of a single host device 12.

For example, a dog training networked system 10 includes individual collars fitted with control module 18, thereby making the collar action device 16. As opposed to shock collars, this embodiment allows a dog to become accustomed to their master or trainer's voice thereby providing positive reinforcement instead of causing the animal to become fearful or aggressive as a result of receiving electrical shocks.

In this embodiment, control module 18 includes audio unit 30 and is battery operated. The dog would be trained with and grow accustomed to the trainer's or owner's voice, rather than an electrical shock. The voice of the trainer or owner will be emitted from speaker 34 to provide the animal feedback.

For example, an invisible boundary, such as a buried electrical wire can define the animal's boundary and control module 18 includes sensors for detecting the invisible fence line. As the animal approaches and/or transgresses the boundary, the voice of the animal's owner may be emitted through speaker 34 to call the animal back within the boundary, and/or a notification can be sent to the host device 12 to indicate the animal has left the boundary. It should be appreciated that this can also be used to monitor a child or children within a yard or daycare facility, where action device 16 is a bracelet or attached to or carried by the child or children in a suitable manner.

Various sensors and devices can also be attached to expansion ports 36 and input/output ports 38. For example, action device 16 (e.g. collar) could also be outfitted with an accelerometer to determine when the animal is in motion, as part of the training feedback to the trainer. Using multiple collars allows a trainer/owner to work with multiple dogs at the same time, while still giving the trainer/owner the ability to isolate control over a single dog when necessary. For example, the trainer/owner can send audio commands to one dog or many dogs at the same time.

From an entertainment perspective, the animal can be given a voice or personality. For example, control module 18 is equipped with prerecorded phrases and/or user generated Content. An owner, through host device 12 can make their animal “talk” by the push of a button through host device 12.

It should be appreciated that this embodiment can be used with other types of animals and not just dogs, for example, performance or other trained animals such as those appearing in movies, plays, and/or circuses.

Intelligent Sprinkler/Irrigation System

Networked system 10 can be utilized as an intelligent sprinkler or irrigation system. For this embodiment, FIGS. 1-4 are applicable networked system 10 configurations, with the networked system 10 configurations of FIGS. 1, 2, 3A, and 3B being preferred.

For example, in this embodiment, a single host device 12 controls multiple action devices 16. Action devices 16 are strategically placed (based on user preference) in an area such as a yard or garden. Action devices 16 may even be integrally or detachably coupled to sprinkler heads. In this embodiment, action devices 16 include multiple sensors, such as, but not limited to, air and soil temperature sensors, soil moisture sensors, humidity sensors, and/or combinations thereof. Data collected from sensors operably associated with action device 16 is relayed to host device 12 for processing via the first and second communication protocols previously discussed Additionally, action devices 16 may include movement mechanisms, such as servos to orient the sprinkler head in various directions, as well as vary the amount of flow through the sprinkler valve.

Host control application 14 is configured to utilize the input received from each action device 16 to determine a intelligent watering plan, including how much water an area would need, the duration of such watering, the orientation of the sprinkler head, and/or adjustments to the sprinkler valve. If networked system 10 is in the first operation mode, (e.g. infrastructure mode), host device 12, through host control application 14 and access point 25, can use the internet to retrieve other data from a weather data service provider to utilize seasonal information and/or local weather forecast(s) to formulate an intelligent plan to provide water to a specific landscape and/or garden.

It should be appreciated that the difference between the first and second operating modes for the intelligent sprinkler system is that when operating in the second operation mode, e.g. ad-hoc mode, host control application 14 is not connected to access point 25 and thus cannot retrieve data from any online weather data service provider. However, host control application 14 may be pre-loaded with historical weather data of the region or area and use the historical weather data in conjunction with the current data inputs from action devices 16 to formulate an intelligent plan to provide water to a specific landscape and/or garden.

Regardless of operating mode, host device 12 allows for control over the entire watering system, such that the user or operator of networked system 10 can initiate watering of one or more action device 16 without having to go outside in bad weather and/or manually adjust sprinkler heads or irrigation control system.

Intrusion Detection System

Networked system 10 can be utilized as an intrusion detection system. For this embodiment, FIGS. 1-4 are applicable networked system 10 configurations, with the networked system 10 configurations of FIGS. 1, 2, 3A, and 3B being preferred.

In this embodiment, action devices 16 are equipped with sensors suitable for intrusion detection, including, but not limited to, window breakage sensors, vibration sensors, movement sensors, cameras, and/or combinations thereof. Installation of networked system 10 does not need a separate specialized server or specialized access point 25. Current security systems do not provide the ability to simultaneously monitor and affect control over equipment attached to the same access point 25 that is currently in place and used by much of the population. In this embodiment, networked system 10 is capable of utilizing the homeowner or building owner's existing wireless equipment and provides the user of networked system 10 the ability to simultaneously monitor and affect control over the equipment (e.g. action devices 16) while present within the structure or from remote locations using host device 12. In infrastructure mode, networked system 10 is configurable to communicate with and request assistance from the local authorities and/or security monitoring company, assuming the local authorities and security monitoring company are equipped to receive communications.

The intrusion detection system may also be operated in ad-hoc mode, with the understanding that the security system does not utilize an access point 25 and does not communicate with any third party such as the local authorities or security monitoring company.

Robotic Search and Rescue

For this embodiment, FIGS. 1-4 are applicable networked system 10 configurations. Search and rescue robots are used to help locate survivors of any natural or manmade disaster. These robots can also be used when the environment for rescuers is unknown and/or unsafe, thus preventing the creation of more individuals requiring rescue or retrieval. Industrial robots, search and rescue robots can be outfitted with both gyroscopes and accelerometers to determine orientation and movement of action device 16 which assists host control application 14 to determine the best path or solution to reach or meet the action device's 16 goal.

In this embodiment, multiple action devices 16 can be deployed under control of a single host control application 14 running on host device 12. Action devices 16 can be equipped with one or more microphones 48, other devices, and detecting sensors via expansion ports 36 and input/output ports 38. This allows for multiple action devices 16 to canvas a large area simultaneously and provide feedback or instructions through speakers 34 and/or a video screen to potential survivors of a calamity. If multiple action devices 16 are used, sonic sensors can provide instantaneous mapping of the environment from each action device's 16 perspective thereby allowing for a faster determination of possible identification of and/or safe havens for trapped survivors.

For a search and rescue system, other devices and sensors can also include, but are not limited to, movement, infrared, visual, auditory, thermal, gas sensing, explosive sensing, the ability to obtain and map topology, and/or combinations thereof.

The Self-Aware embodiment may also be modified for use in the search and rescue embodiment. The flow chart discussed in FIG. 7 would be modified at block 86. Instead of selecting a random wait audio or other wait script, action device 16, will search and take sensory inputs for a given area. In the event other action devices 16 are discovered, the two or more devices will communicate via the second communication protocol (see blocks 88-102 of FIG. 7) regarding its actions in relation to the other. As previously discussed, the learning discussed in relation to personality data may be utilized as guidelines rather than determinate data. Such use allows for self-determining boundaries both for sake of safety of potential survivors and the action devices and for self-preservation of the action device. An example in the search and rescue embodiment is so that action devices 16 will define an area to explore and search and avoid entering into the search area of another action device 16.

In the search and rescue embodiment, the execution of Content can be in real time meaning that host device 12 is equipped for receiving real-time instructions from a user or can execute prewritten and pre-loaded Content. Host device 12 will then transfer the commands from the user to the desired action device 16. As in the other embodiments, the hybrid use of the first and second communication protocols is utilized as well as the unique delta management process.

Instructional Setting

For this embodiment, FIGS. 1-4 are applicable networked system 10 configurations with FIGS. 1 and 3B preferred. Currently in the United States, some classrooms in the K-12 schools have an instructor to student ratio of about 1:30 to about 1:40. In this embodiment, curriculum can be tailored to each student and instructors can identify at-risk pupils that may require additional assistance. This embodiment also provides for the instructor to efficiently manage and track each student's progress.

In this embodiment, host device 12 can be used by an instructor and action devices 16 can be interactive tablets or other suitable devices provided to students. Each classroom is equipped with its own access point 25 to prevent interference and/or joining nearby networked system 10. Through host device 12 and its associated transceiver 24, instructional material, exams, and other materials can be distributed to the students. Action devices 16 send feedback to host control application 14 in real-time monitoring of action device 16. However, feedback can also be delayed and sent to host device 12 at a later time.

For example, an instructor can provide distribute an electronic workbook to each student. As each student progresses in completing the exercises, feedback (including, but not limited to, statistics regarding speed, proficiency, difficulty of the problem) is provided to host control application 14. The feedback may be stored for later use to track each individual student's academic progress. In addition, if a student is excelling, the difficulty of the problems can be increased in real-time to maintain with the student's progress; similarly if a student is struggling, the difficulty can be lessened.

As a student progresses on their assignment, assistance or performance feedback can be provided to the student through on-screen displays or though use of audio unit 30 (with optional headphones plugged into action device 16). In addition, a notification can be sent to the instructor monitoring the host control application 14 to inform the instructor that he/she is needed by the student. If the project is a timed project, at the expiration of the timed project, each action device 16 will prevent any further work by the student, thus creating a fair environment as no single student can obtain an advantage over others by continuing to answer questions after the timer has expired.

The present invention and end uses are not limited to the above examples and descriptions. Other embodiments of the present invention will be apparent to one skilled in the art. The modification of the Content for use in the varying end uses is within the purview of those skilled in the art. As such, the foregoing description merely enables and describes the general uses and methods of the present invention. While certain embodiments of the invention have been described for the purpose of this disclosure, those skilled in the art can make changes without departing from the spirit and scope of the present invention. Thus, the nature of the current invention is defined by the appended claims.

1.-12. (canceled)

13. A networked system defined by a host device and an action device, the networked system configured to operate in either a first or a second operation mode, the networked system comprising:
an action device configured to wirelessly communicate using a first communication protocol and a second communication protocol, said action device including a first wireless transceiver, said first wireless transceiver configured to receive and send wireless communications, a processor operably coupled to said first wireless transceiver, wherein said processor is configured to provide data management of said action device, processing of said wireless communications, and management of movement of said action device;
a host device configured to wirelessly communicate with said action device using said first communication protocol and said second communication protocol, the host device including a second wireless transceiver for receiving and sending wireless communications, a host control application operably coupled to said second wireless transceiver, wherein said host control application is configured to manage and process communications between said host device and said action device, and wherein said host control application provides for command and control of said action device,
wherein said host device and said action device are configured to manage communications with each other through utilize said first and second communication protocols.

14. The networked system of claim 13, wherein said action device further includes an audio unit and a movement effecting device, wherein said audio unit provides for management of audio sound, said audio unit including a microphone for receiving acoustic input and a speaker for emitting acoustic sound, said audio unit operably coupled to said processor, and said movement effecting device operably coupled to said processor, said movement effecting device providing movement of said action device.

15. The networked system of claim 14, wherein said movement effecting device includes one or more of each of the following: a wheel, a servo, a propeller, an actuator, and combinations thereof.

16. The networked system of claim 15, wherein command and control includes audio and/or movement instructions for said action device to implement.

17. The networked system of claim 15, wherein said processor of said action device includes a delta counter, wherein said delta counter is incremented for each byte of incoming data received at said processor from said host device, and wherein said delta counter is decremented for each byte outgoing data from said processor.

18. The networked system of claim 17, wherein said processor is configured to send a wireless communication via the second communication protocol to said host control application to increase the rate of incoming data when a lower threshold of said delta counter is met or surpassed.

19. The networked system of claim 17, wherein said processor is configured to send a wireless communication via the second communication protocol to said host control application to decrease the rate of incoming data when an upper threshold of the delta counter is met or surpassed.

20. The networked system of claim 14, wherein said action device is configured to transmit acoustic input received by said action device to said host device using said first communication protocol to said host device for processing by said host control application.

21. The networked system of claim 14, wherein the host device is any one or more from the group of: a personal computer, a mobile device, a smart device, or combinations thereof.

22. The networked system of claim 21, wherein the networked system is any one of a toy entertainment system, a location-based entertainment system, an animal training system, an animal entertainment system, an intrusion detection system, a sprinkler system, or a robotic search and rescue system.

23. The networked system of claim 13, further comprising:
a tertiary wireless device, wherein said tertiary wireless device includes a wireless transceiver for bi-directionally sending and receiving wireless communications using a third communication protocol, and said action device is configured to communicate using a third communication protocol and thereby serve as a relay between said host device and said tertiary wireless device.

24. The networked system of claim 23, wherein said third communication protocol is selected from the group consisting of IEEE 802.15.4 and successors thereof, IEEE 802.15.1 and successors thereof, other wireless communication systems, and combinations thereof.

25. The networked system of claim 13, wherein the networked system is in said first operating mode, said first operating mode is an infrastructure network.

26. The networked system of claim 13, wherein the networked system is in said second operating mode, said second operating mode an ad hoc network.

27. The networked system of claim 13, further comprising a plurality of action devices configured to wirelessly communication with said host device, wherein said host device is configured to communicate with each action device.

28. The networked system of claim 27 wherein said plurality of action devices is between two (2) and up to, and including, thirty-two (32) action devices.

29.-35. (canceled)

36. A method of operating a networked system, said networked system defined by a host device and an action device, the method comprising:
providing a host device, the host device configured to bi-directionally send and receive wireless communications using a first communication protocol and a second communication protocol;
providing an action device, the action device configured to bi-directionally send and receive wireless communications with the host device;
establishing a thread between said host device and said action device;
sending one or more data files from said host device to said action device using the first communication protocol at an initial data transference rate;
receiving at said host device a throttle control packet from said action device through the second communication protocol, wherein said throttle control packet contains a change to said initial data transference rate;
adjusting said data transference rate at said host device in response to said received throttle control packet thereby creating a new data transference rate; and
sending one or more data files at said new data transference rate from said host device to said action device using the first communication protocol.

37. The method of claim 36, further including a plurality of action devices, wherein the step of establishing a thread includes, establishing a separate thread between said host device and each of said action devices.

38. The method of claim 36, wherein said data transference rate of said thread is variable.

39. The method of claim 37, wherein said data transference rate of each of said threads is variable.

40. The method of claim 37, wherein said plurality of action devices is between two (2) and up to, and including, thirty-two (32) action devices.

41. The method of claim 36, wherein said first communication protocol is transmission control protocol and said second communication protocol is user datagram protocol.

42. The method of claim 41, wherein said networked system is in a first operation mode.

43. The method of claim 42, wherein said first operation mode is infrastructure mode.

44. The method of claim 41, wherein said networked system is in a second operation mode.

45. The method of claim 44, wherein said second operation mode is ad-hoc mode.

46. A method for handling data in a buffer of an action device comprising:
receiving data at an action device from a host device through a first communication protocol;
providing a delta counter for counting bytes of data entering and leaving a buffer of said action device;
incrementing said delta counter for each byte of data entering said buffer;
decrementing said delta counter for each byte of data leaving said buffer;
determining whether a maximum threshold or a minimum threshold is met or surpassed;
generating a throttle packet to change the rate at which data is entering said buffer; and
sending said throttle packet to said host device using a second communication protocol.

47. The method of claim 46, wherein data is entering said buffer at a first rate and data is leaving said buffer at a second rate.

48. The method of claim 46, wherein a ratio of data entering said buffer to data leaving said buffer is selected from the group consisting of 5:1, 4:1, 3:1, and combinations thereof.

49. The method of claim 46, wherein said first communication protocol is transmission control protocol and said second communication protocol is user datagram protocol.

50. The method of claim 46, wherein the steps of receiving data at said action device and sending said throttle packet utilize wireless communication.

51.-57. (canceled)
